(19) United States
(12) Patent Application Publication
(10) Pub. No.: US 2010/0102911 A1
(43) Pub. Date: Apr. 29, 2010

(54) G-force emulator - the power source of C-M3

(75) Inventor: Edgardo Co Timcang, SR., Las Pinas City (PH)

Correspondence Address: Miss Mary Grace Soriano Timcang, 2262 Garnet Drive, Vallejo, CA, 94591, US

(73) Assignee: Miss Mary Grace Soriano Timcang, Vallejo, CA (US)

(21) Appl. No.: 12/288,988

(22) Filed: Oct. 23, 2008

(51) Int. Cl. H01F 7/02; F03G 7/10

(52) U.S. Cl. 335/302; 74/DIG. 9

(57) ABSTRACT

Gravitational force is a consistent process of attraction. Emulating such phenomenon can be done by the use of spring, steel (and/or magnet) and magnet (and/or electromagnet). Although spring works in repel action instead of attraction, the outcome is exactly the same as gravity. By placing a steel (or magnet) and magnet on the opposite ends of the spring, Gravitational Force can be emulated.

### BACKGROUND OF THE INVENTION

When the C-M1 (Version 1) was invented in October 1987, the first thing that came into my mind was, how can I make C-M1 compact so I can use it to replace fossil fuel base prime movers. First I thought of emulating gravity by using the spring. But the problem was the more you compress the spring the higher is the PSI (pounds per square inch) and the tension. Therefore it is not consistent, unlike gravity. Thenceforth, the research went on. Then in July 1988 I thought of combining the spring and magnet (Electromagnet) emulating gravity. The experiment took only two weeks and amazingly the combination of spring and magnet successfully emulates gravity. The G-Force Emulator was not tested, as power source of C-M3, until mid 1989.

Note: 1. C-M1 is a very powerful perpetual motion machine designed for hydroelectric (hydraulic) power generation. C-M1 (Version 3) is now patent pending with a Non-Provisional Patent Application Number: U.S. Ser. No. 12/231,697 and have been granted the Foreign Filing License on Sep. 23, 2008.
2. C-M3 is the compact model of C-M1. C-M3 uses G-Force Emulator as its source of power while C-M1 uses gravity.

### BRIEF SUMMARY OF THE INVENTION

While C-M1 solves the demand for electric energy, C-M3 solves, foremost, the demand for engine replacement. C-M3, which is powered by G-Force Emulator, can be used as prime mover for land, sea and air transportation and many more. Amazingly, it can be used in outer space.

### BRIEF DESCRIPTION OF THE SEVERAL VIEWS OF DRAWINGS

FIG. 1—Depicts the G-Spring 1 in the zero tension position, zero PSI and at fail decompression.

FIG. 2—Depicts the G-Spring 1, in the desired and minimum tension position, at 10 PSI and at 25% compression.

FIG. 3—The G-Spring 1 is in action but the tension remains at 10 PSI even at 35% compression due to Base Magnet 3 attraction of the Moving Steel.

FIG. 4—Depicts the G-Spring 1 in the desired maximum tension position, at 10 PSI and at 45% compression while the Base Magnet is in full action.

### DETAILED DESCRIPTION OF THE INVENTION

### G-Force Emulator

The Gadget has three major parts:
1 G-Spring—act as the gravitational force but in repel motion.
2 Moving Steel (and/or Magnet)—attached to the spring (opposite to Base Magnet), which is the object of attraction by the Base Magnet.
3 Base Magnet (Natural and/or electromagnet)—attracts or draws the Moving Steel that is attached to opposite end of the Spring during compression.

### Calibration

The G-Force Emulator shall be designed and fabricated in accordance with the desired application's specification. For example, a G-Spring can be designed to produce a 5 hp to be used for water pump or 12 hp for flying machine use or 50 hp for small car use and so on.

### Embodiment—How the Gadget Works

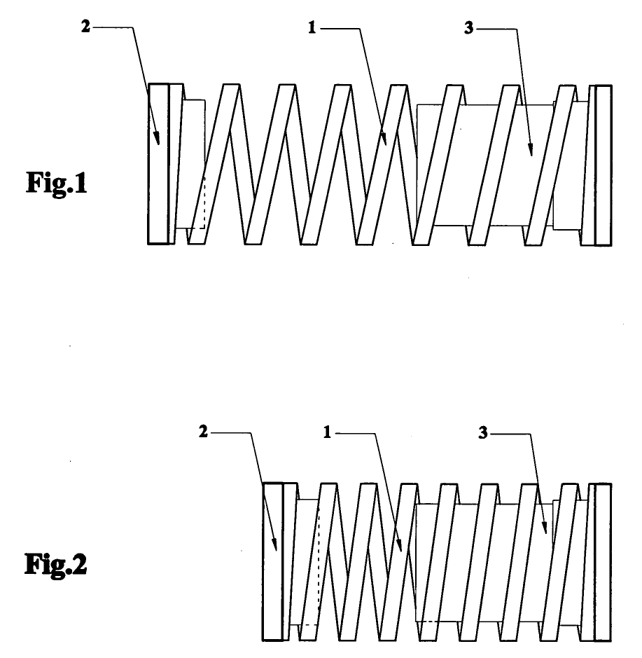

FIG. 1 The G-Force Emulator is completely at rest. No compression therefore no tension, zero PSI and no attraction.

FIG. 2 This figure is the permanent calibration of the gadget. The G-Spring 1 is compressed to a minimum of 25% of the total spring length. In this case the tension has resulted to 10 PSI. This minimum spring compression is more or less permanent in conjunction with its design. This is also the lowest point of travel by the Moving Steel 2 or G-Spring 1. At this stage the Base Magnet 3 is not yet in action that is drawing or attracting the Moving Steel 2.

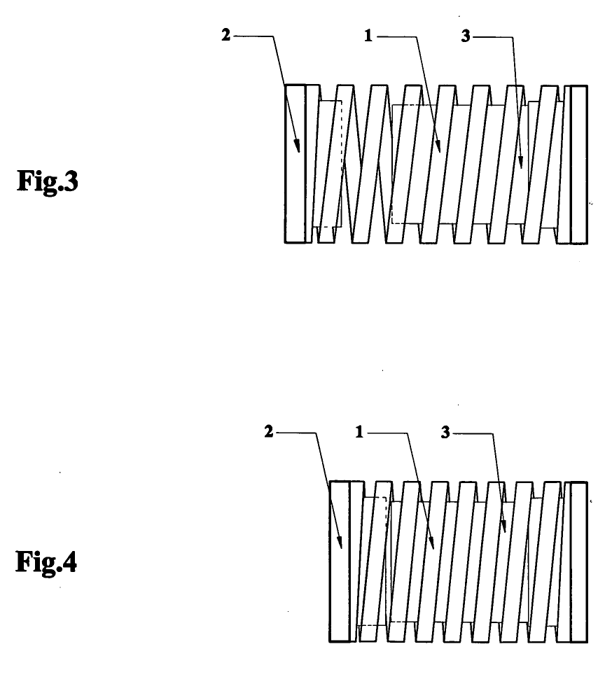

FIG. 3 This figure shows that the G-Spring 1 is now 35% compressed and the Base Magnet 3, which is gradually pulling the Moving Steel 2, maintains the G-Spring 1 tension at 10 PSI.

FIG. 4 The G-Spring 1 is compressed to a maximum of 45% from its total length and the process of attraction by the Base Magnet 3 during compression is in action. Due to this process of attraction, the 10 PSI is maintained and therefore, gravity is emulated.

1. The Base Magnet 3 function is to counteract the tension created by the G-Spring 1 compression by attracting the Moving Steel 2 towards it.

2. The more the G-Spring 1 is compressed the greater the PSI is, but the closer the Moving Steel 2 to the Base Magnet 3, the stronger the attraction (drawing) is.

3. Therefore, the principle and concept prove that with the use of Base Magnet 3 to counteract the G-Spring 1 PSI or tension could result to a consistent PSI thereby emulating the Gravitational Force.

4. Using coil spring or lift spring or any similar spring, does not in any way affect the principle and concept of G-Force emulation.
